(19) United States
(12) Patent Application Publication
(10) Pub. No.: US 2016/0090773 A1
(43) Pub. Date: Mar. 31, 2016

(54) WINDOW SYSTEM FOR A VEHICLE

(71) Applicant: Toyota Motor Engineering & Manufacturing North America, Inc., Erlanger, KY (US)

(72) Inventor: Erik Anthony Wippler, Canton, MI (US)

(21) Appl. No.: 14/502,964

(22) Filed: Sep. 30, 2014

(51) Int. Cl. E05F 15/71; E05F 15/70; E05F 15/689; B60J 1/17

(52) U.S. Cl. CPC E05F 15/71; B60J 1/17; E05F 15/70; E05F 15/689

(57) ABSTRACT

A window system for a vehicle includes a control module in communication with the powered window. The control module can cause the powered window to be positioned in response to a vehicle condition. The vehicle condition can include a vehicle speed and/or temperature. Such positioning can reduce cabin wind noise at certain vehicle speeds. The system can also help reduce internal vehicle temperatures without dependence on air conditioning systems.

### BACKGROUND

The present disclosure relates to a vehicle, and more particularly to a window system therefor.

Vehicles typically include power windows as well as power sunroofs that can be selectively raised, lowered, and/or tiled by actuation of a switch. Power windows are usually inoperable when the vehicle is not running. This is primarily a security feature. Some systems offer the compromise of leaving power applied to the windows until a passenger door is opened, at which time the window power is removed.

Many modern vehicles have a time delay feature, called “retained accessory power”. This allows operation of the windows and some other accessories for ten minutes or so after the engine is stopped. Another feature is “express-down”, which allows the window to be fully lowered with one tap on the switch, as opposed to holding the switch down until the window retracts. Many vehicles also include “express-up” on the driver's window, and recently, some manufacturers have added the feature on all window switches for all passengers' convenience.

Although convenient, all such power window and sunroof systems require manual actuation via a switch system as desired by the operator.

### SUMMARY

The window system described herein selectively positions a powered window of a vehicle in response to a vehicle condition. The window system analyzes vehicle conditions such as speed and temperature. The window system will for example, selectively close the powered window in response to an increase in vehicle speed to facilitate reduction of cabin wind noise at higher speeds, and a reduction of internal vehicle temperatures at lower speeds, to improve fuel efficiency. This can be especially beneficial on convertible-type vehicles.

A window system according to one disclosed non-limiting embodiment, includes a control module in communication with a powered window, the control module operable to position the powered window in response to a vehicle condition.

A computer storage media having embodied thereon computer-useable instructions that, when executed, performs a method, that according to one disclosed non-limiting embodiment, includes selectively positioning a powered window of the vehicle in response to the vehicle condition

The foregoing features and elements may be combined in various combinations without exclusivity, unless expressly indicated otherwise. These features and elements, as well as the operation thereof, will become more apparent in light of the following description and the accompanying drawings. It should be understood, however, that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of a vehicle with a window system;

FIG. 2 is a flow chart illustrating operations of the window system according to one disclosed non-limiting embodiment; and

FIG. 3 is a chart schematically illustrating operations of the window system in response to various conditions.

### DETAILED DESCRIPTION

A window system and a method that selectively positions a powered window of a vehicle in response to vehicle condition are disclosed. The window system can advantageously selectively close the powered window in response to an increase in vehicle speed to facilitate reduction of cabin wind noise at higher speeds, and reduce internal vehicle temperatures at lower speeds without dependence on air conditioning. The window system can provide various automatic positioning features via a display of the vehicle human-machine interface, or via a conventional window switch that includes an “AUTO” position. The display operates as an interface for the user to adjust the window system such as activation speed, window position, system on/off, and other features thereof.

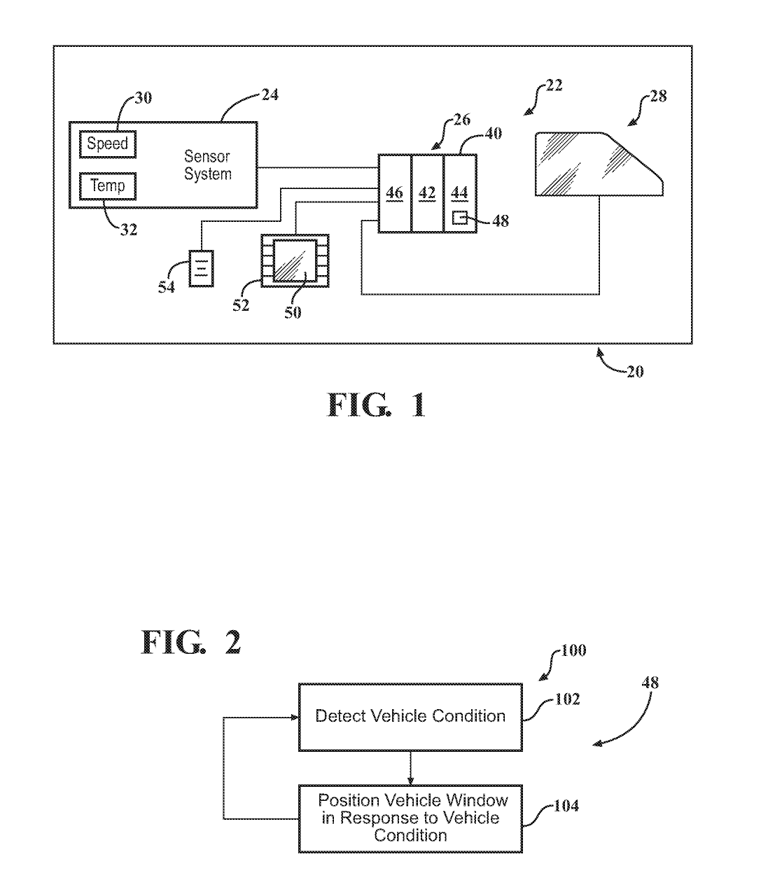

FIG. 1 schematically illustrates a vehicle 20 with a window system 22. The window system 22 is here shown as including a side window of a convertible-type vehicle in the disclosed, non-limiting embodiment, however, it should be appreciated that various vehicle types, windows, and sunroof type panels will also benefit herefrom.

The window system 22 generally includes a sensor system 24, a control system 26, and a powered window 28. It should be appreciated that, although particular systems are separately defined, each or any of the systems may be otherwise combined or segregated via hardware and/or software within the window system 22.

The sensor system 24 may include various sensors operable to identify a condition associated with the vehicle 20. In one disclosed non-limiting embodiment, the sensor system 24 includes a vehicle speed sensor 30. It should be appreciated that other sensors, such as a temperature sensor 32, may be alternatively or additionally utilized in combination with the vehicle speed sensor 30. The temperature sensor 32 may measure the temperature within the vehicle and/or external thereto.

The control system 26 generally includes a control module 40 with a processor 42, a memory 44, and an interface 46. The control module 40 may be a portion of a central vehicle control, a stand-alone unit, a cloud-based system, or other system. The processor 42 may be any type of microprocessor having desired performance characteristics. The memory 44 may include any type of computer readable medium that stores the data and control algorithms 48 described herein below. The interface 46 facilitates communication with the sensor system 24, the powered window 28, and other vehicle systems such as a display 50 in a vehicle human-machine interface 52.

Selection of the automatic positioning of the powered window 28 may be performed via the display 50 of the vehicle human-machine interface 52, or via a conventional window switch 54 that includes for example, an “AUTO” position. Further, the display 50 may provide an interface for the user to configure the window system 22 to operate as desired such as via activation speed, window open position, system on/off, and other features thereof.

With reference to FIG. 2, in one disclosed non-limiting embodiment, an algorithm 48 for operation of the window system 22 is schematically illustrated. The functions of the algorithm 48 are disclosed in terms of functional block diagrams and it should be appreciated that these functions may be enacted in either dedicated hardware circuitry or programmed software routines as a computer readable storage medium for execution as instructions in a microprocessor based electronics control embodiment such as the control system 26. That is, the memory 44 is an example of computer storage media having embodied thereon computer-useable instructions such as the algorithms that, when executed, perform a method 100 of automated window control.

Initially, the method 100 utilizes the vehicle speed sensor 30 to detect a vehicle condition such as vehicle speed (step 102). It should be appreciated that other sensed inputs, including, but not limited to, temperature, wind noise, pressure variance, and others, as well as any combinations thereof, may alternatively, or additionally, be utilized.

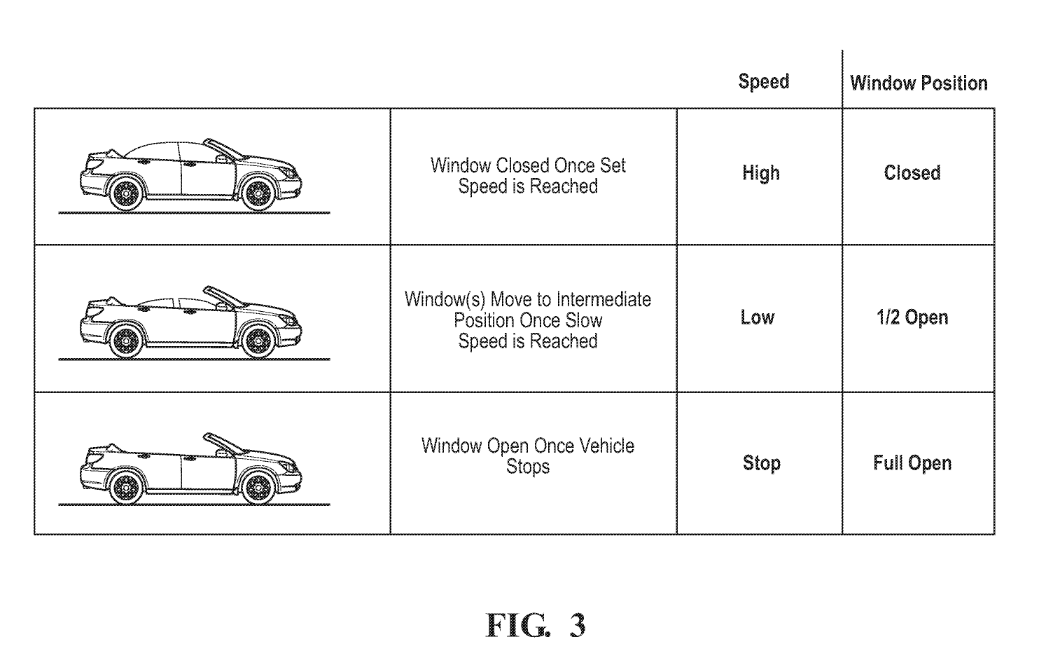

Next, the powered window 28 is positioned in response to the vehicle condition (step 104). In one disclosed non-limiting embodiment, the powered window 28 is raised in response to an increase in vehicle speed (FIG. 3). For example, the powered window 28 opens when the vehicle stops, allowing fresh air to enter the cabin. Once the vehicle starts moving and reaches a certain speed, the powered window 28 automatically rises to a semi closed, then closed position. It should be appreciated that the powered window 28 may be positioned in steps, e.g., closed, half-open, open, or may be or may be continuously variable.

In another disclosed non-limiting embodiment, the powered window 28 is positioned in response to the vehicle speed in combination with another input such as a temperature within the vehicle temperature, a temperature external to the vehicle, whether the vehicle air conditioning system is active, noise and/or other input. Further, other inputs such as a whether rain is detected via operation of the windshield wipers, the location of the vehicle based on demographic, or other map data information indicative of the vehicle location, may be alternatively or additionally utilized to disable operation of the of the window system 22.

Automatic positioning of the powered window 28 may facilitate reduction of cabin wind noise at higher speeds, and reduce internal vehicle temperatures at lower speeds without dependence on air conditioning, thus improving fuel efficiency. This can be especially beneficial on convertible type vehicles.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

1. A window system for a vehicle, comprising:
a powered window; and
a control module in communication with the powered window, the control module causing the powered window to be positioned based on a vehicle speed and whether a vehicle air conditioning system is in operation.

2. (canceled)

3. The system as recited in claim 1, wherein the vehicle speed is determined via a vehicle speed sensor.

4. The system as recited in claim 1, wherein causing the powered window to be positioned is further based on a temperature measured by a temperature sensor in communication with the control module.

5. The system as recited in claim 4, wherein the temperature sensor measures a temperature within the vehicle.

6. The system as recited in claim 4, wherein the temperature sensor measures a temperature external to the vehicle.

7. The system as recited in claim 1, wherein the powered window is a vehicle side window.

8. The system as recited in claim 1, wherein the powered window is a vehicle sunroof.

9. The system as recited in claim 1, further comprising a user interface in communication with the control module.

10. The system as recited in claim 9, wherein the user interface includes a display to change an operation of the powered window.

11. The system as recited in claim 10, wherein the display provides for operational selection of an auto-positioning feature of the powered window, the auto-positioning feature includes relationship with vehicle speed.

12. The system as recited in claim 9, wherein the user interface includes a switch to selectively actuate an auto-positioning feature of the powered window.

13. The system as recited in claim 1, wherein the control module selectively closes the powered window as the vehicle speed increases.

14. The system as recited in claim 13, wherein the powered window is movable at least between an open position, a half-open position and a closed position.

15. A computer storage media having embodied thereon computer-useable instructions that, when executed, performs a method, the method comprising:
detecting a vehicle condition; and
selectively positioning a powered window of the vehicle in response to the vehicle condition.

16. The method as recited in claim 15, wherein the vehicle condition includes a vehicle speed.

17. The method as recited in claim 15, wherein the selectively positioning of the powered window is performed in steps.

18. The method as recited in claim 16, wherein the powered window is closed in response to an increase in vehicle speed.

19. The method as recited in claim 15, wherein the vehicle condition includes a vehicle speed and a location of the vehicle.

20. The method as recited in claim 15, wherein the vehicle condition includes a vehicle speed and a temperature.

21. A window system for a vehicle, comprising:
a powered window; and
a control module in communication with the powered window, the control module causing the powered window to be positioned based on a vehicle speed,
the control module causing the positioning of the powered window based on a vehicle speed to be disabled in response to detecting the operation of a windshield wiper.

22. A window system for a vehicle, comprising:
a powered window; and
a control module in communication with the powered window, the control module causing the powered window to be positioned based on a vehicle speed,
the control module causing the positioning of the powered window based on a vehicle speed to be disabled in response to a geographic location of the vehicle.
